(19) United States
(12) Patent Application Publication
(10) Pub. No.: US 2019/0248950 A1
(43) Pub. Date: Aug. 15, 2019

(54) USE OF OLIGOMERIC STERICALLY HINDERED PHENOL FOR STABILIZATION OF POLYOLS AND POLYURETHANES

(71) Applicant: ITA INTERNATIONAL PTY. LTD., Victoria (AU)

(72) Inventors: Huazhang CHEN, Victoria (AU); Mei DENG, Victoria (AU)

(73) Assignee: ITA INTERNATIONAL PTY. LTD., Victoria (AU)

(21) Appl. No.: 16/327,816

(22) PCT Filed: Jan. 7, 2017
(86) PCT No.: PCT/IB2017/050070

§ 371 Date: Feb. 23, 2019

(30) Foreign Application Priority Data
Sep. 1, 2016 (AU) 2016903496

(51) Int. Cl. C08G 18/48; C08K 5/13; C08L 75/08; C08L 71/02; C08G 18/76

(52) U.S. Cl. CPC C08G 18/4833; C08K 5/13; C08G 2101/0083; C08L 71/02; C08G 18/7621; C08L 75/08

(57) ABSTRACT

A method to stabilize a polyoxyalkylene polyether polyol against oxidative degradation by including therein an oligomeric sterically hindered phenol, namely phenol, 4-alkyl-, reaction products with dicyclopentadiene and isobutylene, having the formula I:

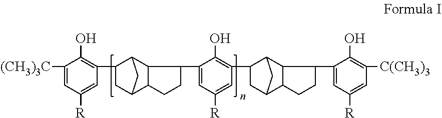

wherein n is an integer ranging from 0 to 10, R is an alkyl group with 12 carbon atoms or less, as an antioxidant stabilizer, optionally in combination with other antioxidants, to said polyether polyol. This invention further relates to polyols stabilized by the method of this invention and to stabilized polyurethanes prepared from such stabilized polyols or stabilizers component.

### BACKGROUND OF THE INVENTION

The present invention relates to the use of an oligomeric sterically hindered phenol, namely phenol, 4-alkyl-, reaction products with dicyclopentadiene and isobutylene, having the formula I:

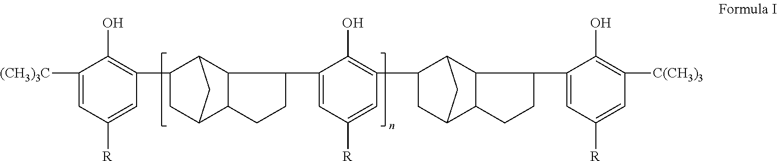

wherein n is an integer ranging from 0 to 10, R is an alkyl group with 12 carbon atoms or less, as a stabilizer for polyoxyalkylene polyether polyols and for polyurethanes produced from the polyoxyalkylene polyether polyols.

Stabilizers against oxidation degradation for polyethers and polyurethanes are well known and typically including a monomer butylated phenol or its esterified product, dialkyl diphenylamines, phenolthiazines, phosphites, and mixtures of compounds of above. For example, U.S. Pat. No. 3,637,865, U.S. Pat. No. 4,228,247 and U.S. Pat. No. 5,143,943.

2,6-Di-tert-butyl-4-methyl phenol (“BHT”) is frequently used for stabilizing polyether polyols, either alone or mixed with other antioxidants described above. However, the use of BHT is limited and disadvantageous. Due to its relatively high volatility and a tendency to migrate into substrates covering the polyurethanes, consequently a strong yellow coloring develops in the substrates in an atmosphere where exist nitrogen oxides (“NOx”), such as in industrial areas or areas with heavy traffic flow. Stabilizers not having these disadvantages are therefore of interest. The object of the present invention is to provide suitable and efficient stabilizers as the replacement of BHT. It has been found that an oligomeric sterically hindered phenol, namely phenol, 4-alkyl-, reaction products with dicyclopentadiene and isobutylene, having the formula I:

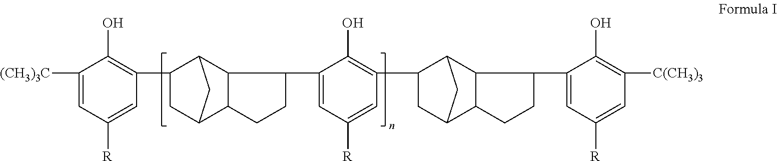

wherein n is an integer ranging from 0 to 10, R is an alkyl group with 12 carbon atoms or less, is a suitable and efficient stabilizer for polyoxyalkylene polyether polyols of molecular weight of from 200 to 10,000.

### SUMMARY OF THE INVENTION

The present invention relates to a method to stabilize a polyoxyalkylene polyether polyol against oxidation degradation having a molecular weight of from about 200 to about 10,000, including adding an oligomeric sterically hindered phenol, namely phenol, 4-alkyl-, reaction products with dicyclopentadiene and isobutylene, having the formula I:

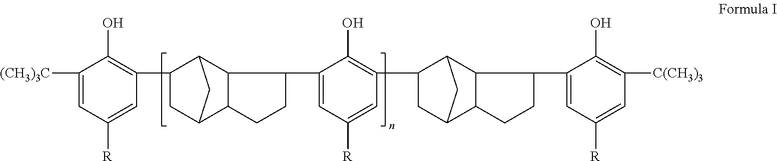

wherein n is an integer ranging from 0 to 10, R is an alkyl group with 12 carbon atoms or less, optionally in combination with other antioxidants, to the polyoxyalkylene polyether polyol.

This invention further relates to polyols stabilized by the method of this invention and to polyurethanes prepared from such stabilized polyols or stabilizers component.

### DETAILED DESCRIPTION OF THE INVENTION

In the industry of polyoxyalkylene polyether polyols, typically a monomer butylated phenol or its esterified product is used as primary oxidant alone or with other antioxidants. Typical examples are 2,6-di-tert-butyl-4-methylphenol (“BHT”), or optionally β-(3,5-di-tert-butyl-4-hydroxylphenyl propionate isooctanol ester (“1135”), n-octadecyl-β-(4-hydroxy-3,5-di-tert-butyl-phenyl)-propionate (“1076”), tetrakis-[methylene(3,5-di-tert-butyl-4-hydroxy-hydrocinnamate)]methane (“1010”), etc.

However, oligomeric butylated phenols are not studied to be applied for stabilization of polyoxyalkylene polyether polyols. It has now been found, that an oligomeric sterically hindered phenol, namely phenol, 4-alkyl-, reaction products with dicyclopentadiene and isobutylene having the formula I:

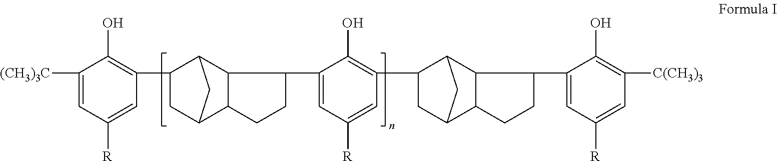

wherein n is an integer ranging from 0 to 10, R is an alkyl group with 12 carbon atoms or less, is ideally suited as a stabilizing antioxidant in the production of polyoxyalkylene polyether polyol having a molecular weight of from about 200 to about 10,000. The said oligomer has multi sterically hindered hydroxyl groups and relatively high molecular weight, which make it ideally non-volatile, non-immigrant and highly efficient. The oligomer can be obtained commercially, or prepared by the reaction of p-alkyl phenol and dicyclopentadiene and subsequently alkylated with isobutylene, in the presence of acid catalysts such as boron trifluoride, as described in the patent U.S. Pat. No. 3305522.

Depending on the basic structure of the polyoxyalkylene polyether polyol, combinations with other antioxidants are also suitable. In general, 0.01 percent to 5 percent preferably 0.01 to 1.0 percent by weight of an oligomeric sterically hindered phenol, namely phenol, 4-alkyl-, reaction products with dicyclopentadiene and isobutylene having the formula I can be used in together with about 0.01 to 0.5 percent by weight of other antioxidant stabilizers, preferably a p,p′-dialkyldiphenylamine such as a reaction product of diphenylamine and diisobutylene, based on the amount of polyoxyalkylene polyether polyol.

The polyoxyalkylene polyether polyols which may be stabilized with the stabilizer compositions of the invention include polyoxyalkylene polyether polyols having 1 to about 10 hydroxyl groups, with molecular weight of from about 200 to about 10,000. The said polyols are prepared by reacting epoxides with combinations of starter alcohols.

In the preparation of polyurethanes and polyurethane foams, the polyol stabilized with the stabilizer compositions of the invention is reacted with a polyisocyanate containing two or more N═C═O groups per molecular in the presence of catalysts, surfactants, water and optionally other auxiliary agents. Although it is advantageous to incorporate the stabilizer compositions into the polyoxyalkylene polyether polyol prior to employing the polyol in the preparation of polyurethanes, when oxidative degradation of the polyoxyalkylene polyether polyol is not a problem, the stabilizer compositions can also be added as an anti-scorch and stabilizing component with other reactants at the time of preparing the polyurethanes and polyurethane foams. The proportion of the stabilizing component, when employing the latter technique, would be based on the proportion of polyoxyalkylene polyether polyol described hereinabove.

The following examples further illustrate the invention in accordance with the principles of this invention, including examples of comparative nature, but are not to be construed as limiting the invention in any way except as indicated by the appended claims.

The oxidative stability (measure of oxidative degradation) of the polyoxyalkylene polyether polyol was determined by placing the sample in a Mettler differential scanning calorimeter and the temperature at which oxidation occurred was recorded. In the stability determination, the weighed polyether polyol samples were placed in a crucible which was placed in the differential scanning calorimeter cell along with a reference crucible. The temperature of the cell was increased at 10° C./minute with an oxygen atmosphere purge. The temperature was plotted on the x axis and energy emitted or absorbed by the sample plotted on the y axis. The temperature at the time of initiation of oxidation was determined by locating the interception of the slope of exotherm deflection (y axis) and the base line x axis. The higher the temperature, the more stable the sample.

To test the property of scorch resistance, polyureyrethane foams were made by reacting the polyether polyol premixed with stabilizing components with other reactants or alternatively adding the stabilizing components to the polyol with other reactants, according to the formulation consisted of the following:

| Polyether polyol | 100 parts by weight |
|---|---|
| | (3000 M.W Hydroxy No. 56) |
| Stabilizing component | 0.80 |
| Water | 5.50 |
| Silicone stabilizer | 1.20 |
| Amine catalyst A-1 | 0.07 |
| Fire retardant | 7.00 |
| Stannous octoate catalyst | 0.25 |
| Toluene diisocyanate 80/20 | 71.39 |

The first 6 components were added by sequence and mixed by stirring in a paper cup for 45 seconds at 1000 rpm, then stannous octoate catalyst was added continuing stirring for 15 seconds at 1000 rpm. After that Toluene diisocyanate 80/20 was added to the other components and stirred for 6 seconds at 2500 rpm. The mixture was then immediately poured into a box and allowed to rise. After 300 seconds from the start of the isocyanate mixing, the foam was moved out and placed in a microwave oven at 50% power for 6 minutes. Thereafter, the foam was allowed to cure at room temperature for 24 hours. The foam was then cut in the middle and discoloration was determined.

### Example 1

Various antioxidants which are used to replace BHT to stabilize polyoxyalkylene polyether polyol were added to a 3000 MW polyether polyol derived from propylene oxide (PO), and tested for oxidative stability as described herein above. Formula I has an average molecular weight of 650 and wherein R is a methyl group.

Parts per Hundred Parts of Polyether Polyol

| | | | | | Initial temperature |
|---|---|---|---|---|---|
| Samples | 1135 | 1076 | 1010 | Formula I | of oxidation ° C. |
| Sample A | — | — | — | — | 158.4 |
| Sample B | 0.39 | — | — | — | 168.0 |
| Sample C | — | 0.39 | — | — | 167.0 |
| Sample D | — | — | 0.39 | — | 169.4 |
| Sample E | — | — | — | 0.39 | 182.3 |

The example shows compared with other monomer butylated phenol antioxidants, under the same usage the oligomeric sterically hindered phenol with the formula I can drastically improve the stability of polyether polyol against oxidative degradation as measured by the initial temperature of oxidation of polyol under an oxygen atmosphere.

### Example 2

Compositions consist of a primary antioxidant (sterically hindered phenol) and a second antioxidant were added to another 3000 MW polyether polyol derived from mixtures of propylene oxide (PO) and ethylene oxide (EO), and tested for oxidative stability as described herein above. Formula I has an average molecular weight of 650 and wherein R is a methyl group.

Parts per Hundred Parts of Polyether Polyol

| | | p,p′-dioctyl | | | | Initial |
|---|---|---|---|---|---|---|
| | | diphenyl | | | Formula | temperature of |
| Samples | BHT | amine | 1076 | 1135 | I | oxidation ° C. |
| Sample A | — | — | — | — | — | 183.3 |
| Sample B | 0.20 | 0.10 | — | — | — | 211.1 |
| Sample C | — | 0.10 | 0.36 | — | — | 208.5 |
| Sample D | — | 0.10 | — | 0.20 | — | 209.2 |
| Sample E | — | 0.05 | — | — | 0.20 | 213.0 |

The results indicate when combined with other synergistic antioxidant, the oligomeric sterically hindered phenol with the formula I is more efficient and more effective, as the usage level of its combination is minimum while the stability of polyol against oxidation is better than other combinations in absence of the oligomeric compound as measured by the initial temperature of oxidation of polyol under an oxygen atmosphere.

### Example 3

Polyurethane (PU) foams were prepared as above with various stabilizing components under the same usage level. Formula I has an average molecular weight of 650 and wherein R is a methyl group.

% By Weight Based on Polyol

| | p,p′-dioctyl | | | | |
|---|---|---|---|---|---|
| | diphenyl | | | | PU Foam |
| Samples | amine | 1076 | 1135 | Formula I | Discoloration |
| Sample A | — | — | — | — | Dark brown |
| Sample B | 0.48 | 0.32 | — | — | yellow |
| Sample C | 0.48 | — | 0.32 | — | light yellow |
| Sample D | 0.48 | — | — | 0.32 | very slight |

The example shows that discoloration and scorch is minimized by adding the combination of the oligomeric sterically hindered phenol with formula I, with a second antioxidant like p,p′-dioctyl diphenyl amine or a reaction product of diphenylamine and diisobutylene.

What is claimed is:

1. A method to stabilize a polyoxyalkylene polyether polyol having a molecular weight of from about 200 to about 10000 comprising adding an antioxidant stabilizer in an amount of about 0.01 percent to 5 percent by weight to said polyol, wherein said stabilizer comprises an oligomeric phenol, 4-alkyl-, reaction products with dicyclopentadiene and isobutylene, having the formula I: 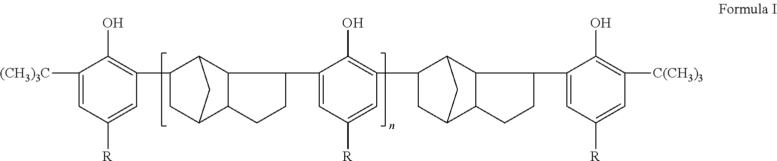
Wherein n is an integer ranging from 0 to 10, R is an alkyl group with 12 carbon atoms or less.

2. A method according to claim 1 to stabilize a polyoxyalkylene polyether polyol having a molecular weight of from about 200 to about 10000 comprising adding an antioxidant stabilizer to said polyol, wherein said stabilizer comprises about 0.01 percent to 1.0 percent by weight, based on the polyether polyol, of an oligomeric phenol, 4-alkyl-, reaction products with dicyclopentadiene and isobutylene having the formula I.

3. A method according to claim 2 wherein said stabilizer is a combination of from about 0.01 percent to 1.0 percent by weight, based on the polyether polyol, of an oligomeric phenol, 4-alkyl-, reaction products with dicyclopentadiene and isobutylene having the formula I, and from about 0.01 percent to 0.5 percent by weight, based on the polyether polyol, of an antioxidant other than the oligomeric phenol, 4-alkyl-, reaction products with dicyclopentadiene and isobutylene having the formula I.

4. A method according to claim 3 wherein said stabilizer is a combination of from about 0.01 percent to 1.0 percent by weight, based on the polyether polyol, of an oligomeric phenol, 4-alkyl-, reaction products with dicyclopentadiene and isobutylene having the formula I, and from about 0.01 percent to 0.5 percent by weight, based on the polyether polyol, of an antioxidant other than the oligomeric phenol, 4-alkyl-, reaction products with dicyclopentadiene and isobutylene having the formula I, wherein the preferable antioxidant is a p,p′-dialkyldiphenylamine such as a reaction product of diphenylamine and diisobutylene.

5. A polyoxyalkylene polyether polyol having a molecular weight of from about 200 to about 10,000 stabilized with from about 0.01 percent to 1.0 percent by weight, based on the polyether polyol, of an oligomeric phenol, 4-alkyl-, reaction products with dicyclopentadiene and isobutylene having the formula I.

6. A polyoxyalkylene polyether polyol having a molecular weight of from about 200 to about 10,000 stabilized with a combination of from about 0.01 percent to 1.0 percent by weight, based on the polyether polyol, of an oligomeric phenol, 4-alkyl-, reaction products with dicyclopentadiene and isobutylene having the formula I, and from about 0.01 percent to 0.5 percent by weight, based on the polyether polyol, of an antioxidant other than the oligomeric phenol, 4-alkyl-, reaction products with dicyclopentadiene and isobutylene having the formula I.

7. A polyoxyalkylene polyether polyol having a molecular weight of from about 200 to about 10,000 stabilized with a combination of from about 0.01 percent to 1.0 percent by weight, based on the polyether polyol, of an oligomeric phenol, 4-alkyl-, reaction products with dicyclopentadiene and isobutylene having the formula I, and from about 0.01 percent to 0.5 percent by weight, based on the polyether polyol, of an antioxidant other than the oligomeric phenol, 4-alkyl-, reaction products with dicyclopentadiene and isobutylene having the formula I, wherein the preferable antioxidant is a p,p′-dialkyldiphenylamine such as a reaction product of diphenylamine and diisobutylene.

8. A polyurethane prepared by reacting a polyether polyol according to claim 5 with a polyisocyanate.

9. A polyurethane prepared by reacting a polyether polyol according to claim 6 with a polyisocyanate.

10. A polyurethane prepared by reacting a polyether polyol according to claim 7 with a polyisocyanate.

11. A polyurethane prepared by including with other reactants a stabilizing component comprising 0.01 percent to about 1.0 percent by weight, based on the polyether polyol employed, of an oligomeric phenol, 4-alkyl-, reaction products with dicyclopentadiene and isobutylene having the formula I.

12. A polyurethane prepared by including with other reactants a stabilizing component comprising 0.01 percent to about 1.0 percent by weight, based on the polyether polyol employed, of an oligomeric phenol, 4-alkyl-, reaction products with dicyclopentadiene and isobutylene having the formula I, and from about 0.01 percent to 0.5 percent by weight, based on the polyether polyol employed, of an antioxidant other than the oligomeric phenol, 4-alkyl-, reaction products with dicyclopentadiene and isobutylene having the formula I.

13. A polyurethane prepared by including with other reactants a stabilizing component comprising 0.01 percent to about 1.0 percent by weight, based on the polyether polyol employed, of an oligomeric phenol, 4-alkyl-, reaction products with dicyclopentadiene and isobutylene having the formula I, and from about 0.01 percent to 0.5 percent by weight, based on the polyether polyol employed, of an antioxidant other than the oligomeric phenol, 4-alkyl-, reaction products with dicyclopentadiene and isobutylene having the formula I, wherein the preferable antioxidant is a p,p′-dialkyldiphenylamine such as a reaction product of diphenylamine and diisobutylene.
